(19) United States
(12) Patent Application Publication
(10) Pub. No.: US 2026/0100736 A1
(43) Pub. Date: Apr. 9, 2026

(54) SYSTEM AND METHOD FOR MULTIPLE-INPUT MULTIPLE-OUTPUT DETECTION USING CANDIDATE REDUCTION AND REDUCED DETECTION LAYERS

(71) Applicant: Samsung Electronics Co., Ltd., Gyeonggi-do (KR)

(72) Inventors: Jaber Mohammad BORRAN, Carlsbad, CA (US); Jung Hyun BAE, San Diego, CA (US)

(21) Appl. No.: 19/347,397

(22) Filed: Oct. 1, 2025

Related U.S. Application Data
(60) Provisional application No. 63/704,908, filed on Oct. 8, 2024.
(60) Provisional application No. 63/795,772, filed on Apr. 28, 2025.

(51) Int. Cl. H04B 7/0456

(52) U.S. Cl. CPC H04B 7/0456

(57) ABSTRACT

A method of detecting signals in a multiple-input multiple-output (MIMO) communication system is provided. The method includes: receiving a signal vector and a channel matrix; computing, for a detection layer, a filter output based on the signal vector and the channel matrix; selecting, as an initial candidate set for the detection layer, a plurality of constellation points; identifying one or more bits using the initial candidate set; computing log-likelihood ratios (LLRs) for the one or more bits; applying a bounding operation to the LLRs to produce bounded LLRs; and outputting the bounded LLRs for decoding.

### CROSS-REFERENCE TO RELATED APPLICATIONS

This application claims the priority benefit under 35 U.S.C. § 119(e) of U.S. Provisional Application Nos. 63/704,908, filed on Oct. 8, 2024, and 63/795,772, filed on Apr. 28, 2025, the disclosures of which are incorporated by reference in their entireties as if fully set forth herein.

### TECHNICAL FIELD

The disclosure generally relates to signal detection in wireless communication systems employing multiple-input multiple-output (MIMO) technology. More particularly, the subject matter disclosed herein relates to improvements to MIMO detection methods using candidate reduction techniques and reduced detection layers.

### SUMMARY

MIMO communication systems use multiple transmit and receive antennas to increase data throughput and link reliability. A central task in such systems is signal detection, where the receiver determines transmitted symbols or bits from noisy received signals.

To solve this problem, some receivers employ detection algorithms such as maximum-likelihood detection or linear filtering followed by candidate evaluation across the full constellation space. Other approaches, such as sphere decoding or successive interference cancellation, attempt to reduce complexity while maintaining accuracy.

One issue with the above types of approaches is that exhaustive candidate evaluation or high-complexity search methods impose heavy computational burdens, particularly for higher-order constellations and large antenna configurations. These methods may also produce unstable or unbounded log-likelihood ratios (LLRs), which degrade decoding performance.

To overcome these issues, systems and methods are described herein for reducing the number of candidate constellation points considered during detection and for limiting processing across detection layers. In particular, the techniques described herein include nearest-neighbor candidate reduction, one-dimensional candidate reduction along in-phase and quadrature axes, and selective omission of candidate generation for less reliable detection layers, together with bounding operations applied to the computed LLRs.

The above approaches improve on previous methods because they significantly reduce detection complexity while producing bounded, reliable LLRs for decoding. As a result, these techniques provide efficient implementation of MIMO receivers that maintain high detection accuracy with reduced processing requirements.

In an embodiment, a method of detecting signals in a MIMO communication system comprises: receiving a signal vector and a channel matrix; computing, for a detection layer, a filter output based on the signal vector and the channel matrix; selecting, as an initial candidate set for the detection layer, a plurality of constellation points; identifying one or more bits using the initial candidate set; computing LLRs for the one or more bits; applying a bounding operation to the LLRs to produce bounded LLRs; and outputting the bounded LLRs for decoding.

In an embodiment, a method of detecting signals in a MIMO communication system comprises: receiving a signal vector and a channel matrix; computing, for a detection layer, a filter output based on the signal vector and the channel matrix; forming a first set of candidate constellation points along a first axis of the filter output; forming a second set of candidate constellation points along a second axis of the filter output; combining the first and second sets to form an initial candidate set for the detection layer; identifying one or more bits using the initial candidate set; computing LLRs for the one or more bits; applying a bounding operation to the LLRs to produce bounded LLRs; and outputting the bounded LLRs for decoding.

In an embodiment, a method of detecting signals in a MIMO communication system comprises: receiving a signal vector and a channel matrix; computing filter outputs for a plurality of layers; selecting an initial candidate set of constellation points for one or more of the layers; computing corresponding constellation points for remaining layers without forming a candidate set for those layers; identifying one or more bits from the plurality of layers, including the remaining layers; computing LLRs for the one or more bits; applying a bounding operation to the LLRs to produce bounded LLRs; and outputting the bounded LLRs for decoding.

### BRIEF DESCRIPTION OF THE DRAWINGS

In the following section, the aspects of the subject matter disclosed herein will be described with reference to exemplary embodiments illustrated in the figures, in which:

FIG. 1 is a diagram illustrating an embodiment of a nearest-neighbor initial candidate reduction (ICR) set in a MIMO detector, including selection of constellation points closest to a filter output as candidate points;

FIG. 2 is a flowchart illustrating a method of MIMO detection using nearest-neighbor ICR, including candidate selection based on distance from a filter output and application of LLR bounding, according to an embodiment;

FIG. 3 is a diagram illustrating an embodiment of a one-dimensional ICR set in a MIMO detector, including formation of a cross-shaped candidate set from in-phase and quadrature axis points;

FIG. 4 is a flowchart illustrating a method of MIMO detection using one-dimensional ICR, including decomposition of symbols into real and imaginary parts and formation of a cross-shaped candidate set, according to an embodiment;

FIG. 5 is a diagram illustrating an embodiment of reduced detection layers in a MIMO detector, including omission of candidate set selection for one or more detection layers, according to an embodiment;

FIG. 6 is a flowchart illustrating a method of MIMO detection using reduced detection layers, including selecting layers for candidate set formation based on reliability, according to an embodiment;

FIG. 7 is a block diagram of an electronic device in a network environment, according to an embodiment; and

FIG. 8 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and case of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

“MIMO communication system” as used herein refers to a wireless communication system employing multiple transmit and multiple receive antennas for simultaneous transmission of data streams. Some examples of “MIMO communication system” are LTE, 5G New Radio (NR) and WiFi systems. “Signal vector” as used herein refers to a received set of samples representing signals collected at multiple receive antennas in a MIMO system. Some examples of “signal vector” are y in an Nᵣ×1 MIMO model, where each entry corresponds to the received symbol at a given antenna. “Channel matrix” as used herein refers to a matrix representing the propagation characteristics between transmit and receive antennas in a MIMO system. Some examples of “channel matrix” are an Nᵣ×Nₜ matrix H in a channel model. “Detection layer” as used herein refers to a processing stage in a MIMO detector corresponding to the estimation of one transmitted symbol stream. Some examples of “detection layer” are a layer corresponding to symbol xo in an LMMSE detector.

“Filter output” as used herein refers to an estimate of a transmitted symbol in a MIMO detector, computed from the received signal vector and channel matrix using a linear detection filter. Some examples of “filter output” are an output z obtained from an LMMSE filter. “Candidate set” as used herein refers to a subset of constellation points selected for evaluating symbol or bit hypotheses in a MIMO detector. Some examples of “candidate set” are a nearest-neighbor subset of points around a filter output. “Constellation points” as used herein refers to discrete complex-valued symbols in a modulation scheme, each representing a unique bit pattern. Some examples of “constellation points” are the symbols in a 16-QAM grid, a 64-QAM constellation, or a 256-QAM constellation. “LLRs” as used herein refers to log-likelihood ratios, which quantify the relative likelihood of a bit being a “0” or “1” based on a received signal and channel conditions. Some examples of “LLRs” are computed from candidate constellation points in a nearest-neighbor method.

“Bounding operation” as used herein refers to a process of constraining LLR values to prevent extreme magnitudes that could overwhelm a decoder. Some examples of “bounding operation” are saturation (clipping) of LLRs to a fixed threshold. “Counter-hypothesis constellation point” as used herein refers to constellation symbol included in a candidate set to ensure that bit values (“0” and “1”) are represented for a given bit position. Some examples of “counter-hypothesis constellation points” are symbols that map to bit value “0” when all nearest neighbors correspond to bit value “1.” “Symbol likelihoods” as used herein refers to probability or metric values that indicate how well a candidate constellation symbol matches the received signal given the channel conditions. Some examples of “symbol likelihoods” are likelihood values computed for candidate symbols in a nearest-neighbor set or in a one-dimensional cross-shaped set, which are then mapped to bit values for LLR calculation. “LMMSE” as used herein refers to a linear minimum mean square error filter, which produces an estimate of a transmitted symbol by minimizing the mean square error between the estimated and actual received signals while accounting for noise. Some examples of “LMMSE” are filter outputs used as initial candidates in MIMO detection.

The systems and methods described herein provide improved signal detection techniques for MIMO communication systems. A receiver obtains a signal vector and a channel matrix, computes filter outputs for one or more detection layers and then applies candidate reduction techniques to limit the number of constellation points considered during detection. In some embodiments, nearest-neighbor ICR is performed by selecting constellation points closest to a filter output. In other embodiments, one-dimensional ICR is performed by forming candidate sets along in-phase and quadrature axes and combining them into a cross-shaped set. In still other embodiments, candidate set selection is omitted for certain detection layers, thereby reducing overall detection complexity.

After candidate sets are determined, the receiver identifies one or more bits from the detection layers, computes LLRs for the bits, and applies a bounding operation, such as clipping or saturation, to produce bounded LLRs. These techniques reduce the computational burden of MIMO detection while maintaining reliable soft information for decoding. By selectively reducing candidate sets and layers, the disclosed approaches achieve improved tradeoffs between accuracy and complexity, allowing efficient implementation of MIMO receivers suitable for high-order constellations and large antenna configurations.

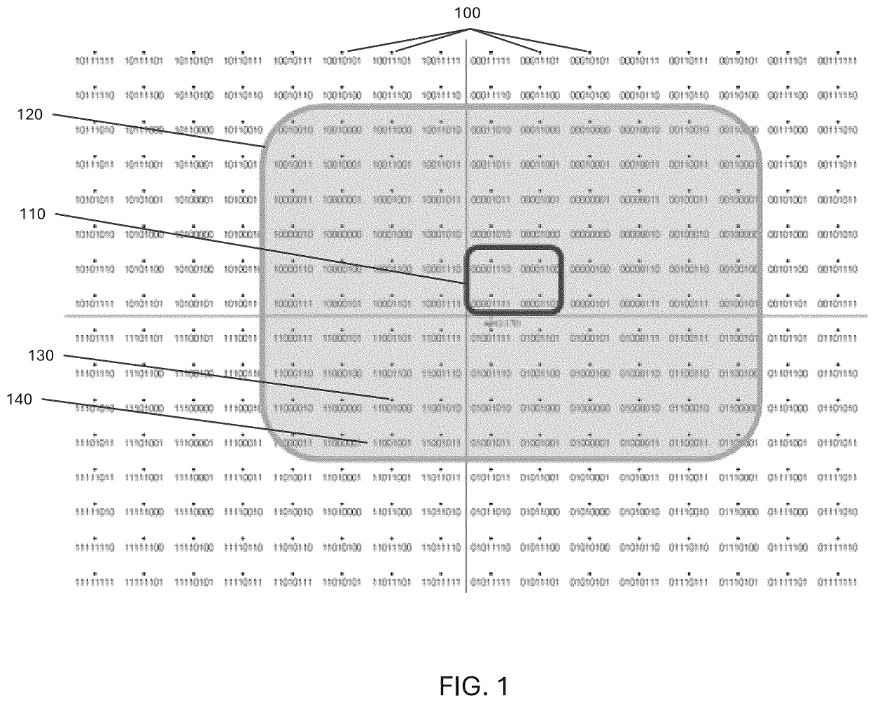

FIG. 1 is a diagram illustrating an embodiment of a nearest-neighbor ICR set in a MIMO detector, according to an embodiment.

Referring to FIG. 1, a constellation diagram including a plurality of constellation points 100 is shown. Each constellation point 100 is associated with a bit label 140 indicating the binary value corresponding to that symbol. A filter output corresponding to a detection layer is indicated at filter output 110. Rather than evaluating all constellation points, a nearest-neighbor candidate region 120 is formed around the filter output 110, and candidate constellation points 130 within this region are selected as the initial candidate set for detection. By limiting evaluation to constellation points closest to the filter output, detection complexity is reduced while maintaining accuracy.

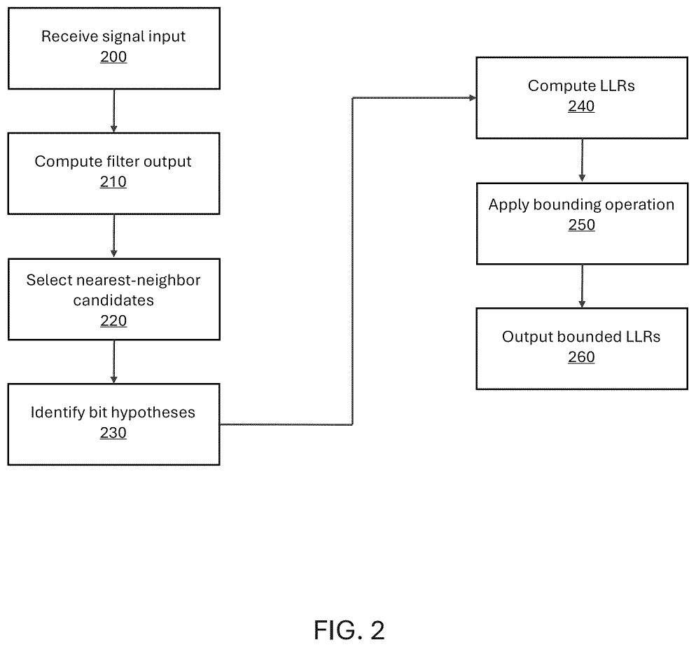

The operation of selecting nearest-neighbor candidates around the filter output 110, as illustrated in FIG. 1, can be understood in the context of a detection method shown in FIG. 2.

FIG. 2 is a flowchart illustrating a method of MIMO detection using nearest-neighbor ICR, according to an embodiment.

Referring to FIG. 2, at 200, a receiver obtains a received signal vector y corresponding to a transmission over a MIMO channel. In one embodiment, the MIMO system comprises Nₜ transmit antennas and Nᵣ receive antennas, and the received signal vector y has dimension Nᵣ×1. The received signal can be expressed as equation (1):

$$y = Hx + n \qquad ( 1 )$$

where H is an Nᵣ×Nₜ channel matrix representing complex channel gains between transmit and receive antennas, x is an Nₜ×1 transmitted symbol vector drawn from a modulation constellation (e.g., QAM), and n is an Nᵣ×1 noise vector, modeled as circularly symmetric complex Gaussian noise with variance σ².

The channel matrix H may be estimated using pilot or reference signals transmitted by the MIMO system. In some embodiments, the channel estimation is performed by a least-squares or MMSE estimator, and the estimated channel H is provided as input to the detector. The signal vector y and channel matrix H thus serve as the primary inputs for the detection process.

At 210, the detector computes a filter output corresponding to a detection layer based on the received signal vector and channel matrix. In one embodiment, the filter output is obtained using an LMMSE filter. The LMMSE filter provides a soft estimate of the transmitted symbol for the detection layer by balancing interference suppression with noise enhancement.

The filter output can be expressed as equation (2):

$$z = {W}^{H} y \qquad ( 2 )$$

where W is a detection filter matrix given by equation (3):

$$W = {( {H}^{H} H + {σ}_{n}^{2} I )}^{- I} {H}^{H} \qquad ( 3 )$$

$$with {σ}_{n}^{2}$$

denoting a noise variance, I the identity matrix, and (⋅)^{H} the Hermitian transpose.

In other embodiments, the filter output may be generated using alternative linear filters, such as zero-forcing (ZF) or matched filtering (MF). Regardless of the implementation, the filter output z serves as a reference point in the signal constellation, from which candidate constellation points are selected in the following step.

At 220, the detector forms an initial candidate set for the detection layer by selecting constellation points that are nearest to the filter output computed in 210. Let the filter output for the layer be denoted z, and let the full modulation constellation be denoted S. Instead of exhaustively considering all points in S, which would be computationally expensive for high-order constellations, the method selects only those constellation points lying within a nearest-neighbor region of z.

In one embodiment, a predetermined number K of points closest to z are selected according to Euclidean distance as shown in equation (4):

$$d ( s ) = {‖ z - s ‖}^{2} , s ∈ S , \qquad ( 4 )$$

with the K points having the smallest d(s) forming the initial candidate set C⊆S. This distance-based approach is illustrated in FIG. 1, where the candidate set corresponds to the constellation points 130 lying within the nearest-neighbor region 120 of the filter output 110.

Unlike detectors that require inclusion of a counter-hypothesis constellation point for each bit position (to ensure both bit values are represented), the disclosed method does not require that constraint. Instead, the initial candidate set may include only nearest-neighbor points to the filter output, even if all bit hypotheses are not explicitly present. This reduction substantially lowers complexity while allowing accurate output generation when coupled with subsequent LLR bounding.

In certain embodiments, the number of nearest neighbors K may be fixed (e.g., 4 or 8 points for a QAM constellation), while in other embodiments the number of nearest neighbors K may be dynamically adjusted according to channel conditions, SNR or layer reliability. Candidate set selection may also be implemented per detection layer in an ordered successive interference cancellation (OSIC) or layered detection framework.

At 230, the detector identifies one or more bit hypotheses for the detection layer using the initial candidate set C selected in 220. Each constellation symbol s∈S is associated with a binary label b(s)=└b₁(s), b₂(s), . . . , b_{M}(s)┘, where M is the number of coded bits per modulation symbol.

For each bit position m, the detector forms a set of candidate points consistent with a hypothesized bit value in equation (5):

$${C}_{m}^{0} = \{ s ∈ C : {b}_{m} ( s ) = 0 \} , {C}_{m}^{1} = \{ s ∈ C : {b}_{m} ( s ) = 1 \} \qquad ( 5 )$$

The sets

$${C}_{m}^{0} and {C}_{m}^{1}$$

represent the available hypotheses for bit m. These subsets are carried forward into the log-likelihood ratio computation of step 240.

In some cases, one of the sets may be empty (e.g.,

$${c}_{m}^{1} = ∅ )$$

because all selected nearest-neighbor symbols map to the same bit value. This reflects an intentional reduction in complexity: unlike approaches that require explicit inclusion of a “counter-hypothesis” point for each bit, the disclosed method allows certain bit hypotheses to be absent from the candidate set. As described later, bounding of the LLRs (step 250) ensures that valid decisions are still obtained.

For example, under 16-QAM mapping, if the candidate set includes points labeled [1011], [1001], [1010], and [1000], then the first bit is always “1” and the second bit is always “0,” while the third and fourth bits vary depending on the symbol. The available hypotheses are thus directly extracted from the selected candidates.

This process is illustrated in FIG. 1, where candidate constellation points 130 near the filter output 110 are annotated with binary labels 140, and these labels provide the hypothesized bit values carried forward for subsequent likelihood computations.

At 240, the detector computes LLRs for the bits identified from the candidate set. The LLRs represent a measure of confidence in whether a given bit is a “0” or a “1,” conditioned on the received signal and the channel.

In one embodiment, the detector evaluates likelihoods for each candidate constellation point in the initial set, then maps those likelihoods to the corresponding bit values. A comparison between the likelihoods associated with bit “0” and those associated with bit “1” yields the LLR for that bit.

Because the initial candidate set is reduced to nearest neighbors, only a limited subset of constellation points contributes to the LLRs. This reduction lowers computational complexity compared to approaches that consider the full constellation. If all candidates in the set correspond to the same bit value at a given position, the LLR reflects high confidence for that value. As described below in step 250, bounding ensures that the LLRs remain stable in such cases.

The resulting LLRs are outputs that can be provided to a channel decoder (e.g., a turbo or LDPC decoder) for error correction.

At 250, the detector applies a bounding operation to the LLRs computed in 240 to produce bounded LLRs suitable for decoding. The purpose of bounding is to prevent LLRs from reaching excessively large magnitudes, which can occur when the reduced candidate set does not include a counter-hypothesis for a particular bit position. Without bounding, such extreme values may overwhelm the decoder or reduce numerical stability.

In one embodiment, bounding is performed by saturation (clipping), where LLR values above a predetermined positive threshold are set to that threshold and values below a predetermined negative threshold are set to that negative threshold. In another embodiment, thresholding is used: if all candidates in the initial set correspond to the same bit value at a given position, the LLR for that bit is assigned a fixed extreme value consistent with the observed hypothesis.

The bounding limits may be fixed or adaptive. For example, the thresholds may be adjusted according to system conditions such as estimated noise level, modulation order or the reliability of the detection layer. Adaptive bounding allows stronger channels to use wider ranges while weaker channels are limited to narrower bounds, thereby maintaining stability across different operating conditions.

Bounding may be applied on a per-bit and per-layer basis, and can be carried out either immediately after the LLRs are computed or prior to their delivery to the decoder. The operation is not tied to the candidate selection described in step 220, and ensures that reliable outputs are available even when certain hypotheses are omitted.

At 260, the bounded LLRs generated in 250 are provided as outputs to a channel decoder. The decoder may be, for example, a turbo decoder, an LDPC decoder, or another forward error correction (FEC) module in the receiver chain.

The output may be delivered as part of a signal-processing pipeline in a modem, either through hardware registers, shared memory, or direct streaming to the decoding stage. In one embodiment, the bounded LLRs are stored for use in iterative detection and decoding. In another embodiment, the values may be forwarded for one-pass decoding.

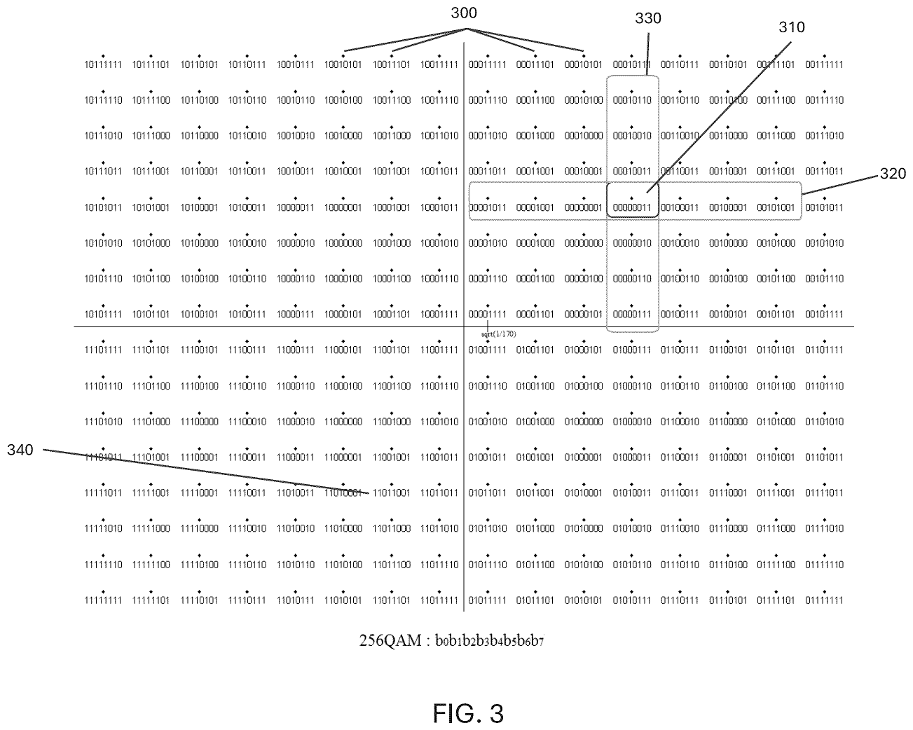

The flowchart of FIG. 2 illustrates a nearest-neighbor ICR approach, in which candidate points are selected according to their distance from the filter output. In an alternative embodiment, illustrated in FIG. 3, candidate reduction is performed using a one-dimensional ICR approach, where candidate points are chosen along the in-phase and quadrature axes to form a cross-shaped candidate set.

FIG. 3 illustrates an embodiment of a one-dimensional ICR set in a MIMO detector, shown here for a 256 QAM constellation. FIG. 3 includes a plurality of constellation points 300, each associated with a unique bit label 340 representing the symbol mapping of the modulation scheme. A filter output 310 is identified within the constellation space, shown as a box, representing the symbol estimate for a given detection layer. From this filter output, candidate points are selected along the orthogonal axes. A first subset of candidates 320 is formed along the quadrature (Q) axis, and a second subset of candidates 330 is formed along the in-phase (I) axis. The union of these axis-based subsets yields a cross-shaped initial candidate set centered on the filter output 310, which reduces candidate complexity while maintaining representative coverage of the constellation.

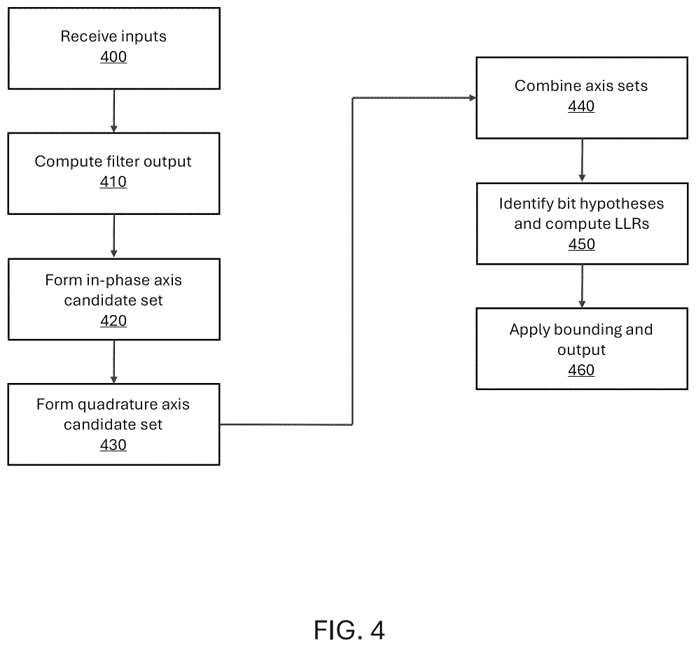

FIG. 4 provides a flowchart of a method implementing the one-dimensional ICR approach of FIG. 3, showing how candidate sets are formed along orthogonal axes and then combined for subsequent bit identification, LLR computation, and bounding.

Referring to FIG. 4, at 400, the detector receives a signal vector y corresponding to transmissions over the MIMO channel, along with a channel matrix H representing propagation conditions between transmit and receive antennas. This step may be the same as or similar to step 200 of FIG. 2, and provides the inputs for detection. In practice, the channel matrix H may be obtained using pilot or reference signals and estimated through techniques such as least-squares or MMSE estimation. The received signal vector y captures the noisy superposition of transmitted symbols at the antennas. Together, y and H establish the starting point for the one-dimensional candidate reduction method described hereinafter.

At 410, the detector computes a filter output for the detection layer based on the received signal vector y and channel matrix H. This step is the same as or similar to step 210 of FIG. 2, where the filter output may be obtained using an LMMSE filter or an alternative linear filter such as ZF or MF. The filter output provides a complex-valued estimate of the transmitted symbol for the detection layer and serves as the reference point for one-dimensional candidate reduction. In particular, the real part of the filter output forms the in-phase axis used in step 420, while the imaginary part of the filter output forms the quadrature axis used in step 430.

At 420, the detector forms an in-phase axis candidate set by selecting constellation points that lie closest to the real part of the filter output computed in step 410. This step differs from the nearest-neighbor approach of FIG. 2, which evaluates distances in two dimensions, by instead restricting the selection to one dimension along the in-phase axis.

In one embodiment, the detector evaluates the Euclidean distance (ED) between the real part of the filter output and the real coordinate of each constellation symbol, and selects a predetermined number of nearest neighbors along this axis. For example, if the filter output has a real component Re(z), then the set of in-phase candidates may be formed by choosing the K_{I} constellation points whose real parts are closest to Re(z). In another embodiment, the number of candidates K_{I} is adjusted dynamically according to SNR, modulation order or reliability of the detection layer.

By confining candidate selection to the in-phase axis, the method reduces the number of points that are evaluated while ensuring that the real dimension of the symbol space is represented in subsequent detection and LLR computation. The in-phase candidate set is later combined with the quadrature-axis candidate set, as described in step 440, to form a cross-shaped initial candidate set.

At 430, the detector forms a quadrature axis candidate set by selecting constellation points closest to the imaginary part of the filter output determined in step 410. This step is analogous to step 420, except that the selection is restricted to the Q axis.

In one embodiment, a fixed number of nearest neighbors are chosen along the Q axis, while in another embodiment the number of points is varied according to operating conditions such as SNR or modulation order. Together with the in-phase candidate set from step 420, the quadrature candidate set provides coverage along the imaginary dimension of the symbol space. These sets are subsequently combined in step 440 to form a cross-shaped initial candidate set.

At 440, the detector combines the in-phase candidate set from step 420 with the quadrature candidate set from step 430 to form a cross-shaped initial candidate set. The union of these sets ensures that both the real and imaginary dimensions of the constellation are represented, even though only one-dimensional reductions were performed in the previous steps.

In one embodiment, any duplicate symbol that appears at the intersection of the two axis sets (e.g., the point closest to the filter output along both axes) is included only once in the combined set. The resulting cross-shaped configuration provides a smaller number of candidate points than a two-dimensional nearest-neighbor approach.

This cross-shaped initial candidate set corresponds to the arrangement illustrated in FIG. 3, where selected candidates extend horizontally along the I axis and vertically along the Q axis relative to the filter output.

At 450, the detector identifies bit hypotheses for the detection layer using the cross-shaped initial candidate set formed in step 440. Each constellation symbol in the candidate set is associated with a binary label, and the bit positions of those labels provide the hypothesized values carried forward for output detection.

This step is the same as or similar to steps 230 and 240 of FIG. 2, except that the available hypotheses are determined from the axis-based cross set rather than from a two-dimensional nearest-neighbor region. In one embodiment, subsets of the candidate set are formed for each bit position according to the corresponding bit value (e.g., a subset for bit=0 and a subset for bit=1). If one subset is empty because all selected candidates map to the same bit value, no counter-hypothesis symbol is forced into the set. This omission reflects a key aspect of the disclosed methods, reducing complexity compared to conventional approaches.

LLRs for one or more bits of the detection layer are then computed from the available hypotheses. In one embodiment, likelihoods associated with the candidate symbols are mapped to bit values and compared to determine the relative confidence of a “0” or “1.” As described in step 460, bounding is applied to ensure that reliable outputs are produced even when counter-hypotheses are missing.

At 460, the detector applies a bounding operation to the LLRs computed in step 450 to produce bounded LLRs suitable for decoding. This step is the same as or similar to steps 250 and 260 of FIG. 2, where bounding is performed by saturation (clipping) or thresholding to prevent extreme values when counter-hypotheses are absent.

The bounding limits may be fixed or adaptive, depending on system conditions such as noise level, modulation order or layer reliability. The resulting bounded LLRs are then provided as output to a channel decoder, such as a turbo decoder or LDPC decoder.

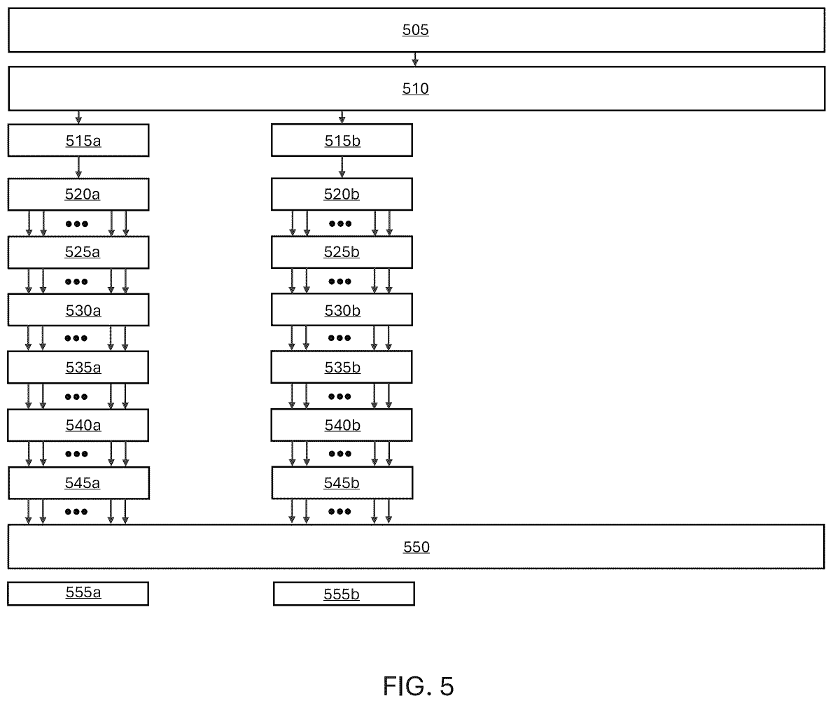

FIG. 5 builds on the methods illustrated in FIGS. 3 and 4 by showing an embodiment of MIMO detection using reduced detection layers. Unlike the nearest-neighbor and one-dimensional candidate reduction techniques described previously, this embodiment reduces overall detection complexity by applying candidate set selection and ED computation to only a subset of detection layers, while other layers may be approximated or omitted.

Referring to FIG. 5, the detector receives, at 505, a received signal vector y and a channel matrix H. At 510, common variables are determined for use across multiple detection layers. For example, 515a corresponds to common variables for layer 0 and 515b corresponds to common variables for layer 1.

Each layer begins with column ordering. In the embodiment shown, 520a represents column ordering for layer 0 in the order [x₀, x₁, x₂, x₃, x₄, x₅, x₆, x₇], while 520b represents column ordering for layer 1 in the order [x₁, x₀, x₂, x₃, x₄, x₅, x₆, x₇]. Based on this ordering, an initial candidate symbol is determined. At 525a, a rank-8 LMMSE filter is applied to obtain a soft estimate of symbol x₀, and at 525b, the same filter is applied to obtain an initial candidate of symbol x₁. The LMMSE operation balances interference suppression and noise enhancement and provides the reference point for candidate selection.

At 530a, candidate selection is performed for symbol x₀, and at 530b, candidate selection is performed for symbol x₁. In one embodiment, candidate selection uses nearest-neighbor reduction as in FIG. 2; in another embodiment, candidates may be drawn from one-dimensional axis subsets as in FIG. 4. In either case, the number of candidate points is smaller than the full constellation, reducing computational load.

Successive interference cancellation (IC) or slicing is then performed. At 535a, IC/slicing is carried out to determine the remaining symbols x₁, x₂, x₃, x₄, x₅, x₆, x₇ given a candidate for x₀. Similarly, at 535b, IC/slicing is performed to determine the remaining symbols x₀, x₂, x₃, x₄, x₅, x₆, x₇ given a candidate for x₁.

ED computations follow. At 540a, ED is computed for layer 0 candidates, and at 540b, ED is computed for layer 1 candidates. Minimum ED determinations are then performed. At 545a, a minimum ED calculation is carried out for all symbol bit signs of x₀, x₁, x₂, x₃, while at 545b, the same calculation is performed for the reordered detection including x₁.

The results are combined in a joint LLR calculation at 550, which aggregates the per-branch computations into final LLRs for decoding. The diagram illustrates two representative reduced detection branches: 555a (branch 0) corresponds to the sequence of operations 515a-545a for layer 0, and 555b (branch 1) corresponds to the sequence of operations 515b-545b for layer 1.

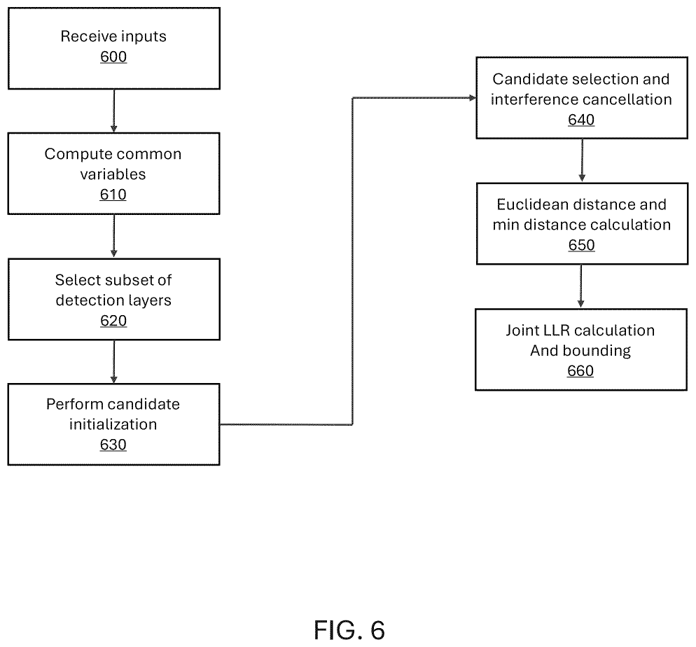

By processing only a subset of detection layers in this manner, FIG. 5 illustrates how the disclosed methods achieve significant reductions in computational complexity while still maintaining reliable output information for decoding. The operations shown in FIG. 5 may be further understood in the context of the method show in FIG. 6.

FIG. 6 is a flowchart illustrating a method of MIMO detection using reduced detection layers, according to an embodiment.

Referring to FIG. 6, at 600, the detector receives a signal vector y and a channel matrix H. This step is the same as or similar to step 200 of FIG. 2 and step 400 of FIG. 4. The signal vector y represents the noisy received symbols across the antennas, while the channel matrix H characterizes the propagation conditions between transmit and receive antennas. In one embodiment, H may be obtained from pilot or reference signals and estimated using known techniques such as least-squares or MMSE estimation. These inputs form the basis for subsequent reduced detection layer processing, in which candidate set selection is applied selectively to only certain layers while other layers are omitted to lower complexity.

At 610, the detector computes common variables that are reused across multiple detection layers. This step differs from the corresponding filter computations in FIG. 2 and FIG. 4 in that certain pre-processed terms are shared between branches to avoid redundant calculations. In one embodiment, the common variables include matrix products derived from the channel matrix H, noise variance estimates, and partial results of the LMMSE filter computation. By storing and reusing these quantities, the detector avoids repeating the same operations for each detection layer, thereby reducing complexity.

For example, a detection filter matrix may be computed once from the channel matrix H and applied to multiple layers, while normalization factors or residual interference estimates may also be maintained in the common variable block. As shown in FIG. 5, these common variables are provided to each detection branch (e.g., 515a, 515b), allowing per-layer operations to begin with shared pre-computed inputs rather than recalculating them independently.

At 620, the detector selects a subset of detection layers for candidate set formation and omits at least one layer from that process. This step represents a core aspect of the reduced detection layers approach. Instead of applying full candidate reduction and likelihood computation across all layers, the method focuses on layers that contribute more reliably to detection accuracy.

In one embodiment, the subset is chosen based on channel reliability. For example, detection layers corresponding to symbols with higher SNR ratios or stronger channel gains may be selected, while layers with lower reliability are omitted. In another embodiment, ordering strategies such as sorted QR decomposition (SQRD) or LMMSE ordering are used to rank layers by strength, with only the top-ranked layers undergoing full candidate set selection.

The omitted layers are not ignored entirely; rather, they may be processed using simplified techniques, such as applying a hard symbol decision or reusing interference estimates from the selected layers. By doing so, the detector reduces the computational load of candidate evaluation and ED calculations.

At 630, the detector performs candidate initialization for the subset of detection layers selected in step 620. This step is the same as or similar to the filter output computations described at step 210 of FIG. 2 and step 410 of FIG. 4, except that here the initialization is applied selectively to only the chosen layers.

In one embodiment, a LMMSE filter is used to obtain an estimate of the transmitted symbol for each selected layer. This estimate serves as the reference point around which candidate constellation points will later be chosen. For example, as illustrated in FIG. 5, block 525a corresponds to generating an initial candidate for x₀ and block 525b corresponds to generating an initial candidate for x₁, each based on a rank-8 LMMSE computation.

By limiting this initialization to selected layers rather than all layers, the method avoids unnecessary filter evaluations, thereby reducing the number of complex matrix operations required. In alternative embodiments, linear filters such as ZF or MF may be used for initialization.

At 640, the detector performs candidate selection and IC for the subset of detection layers initialized in step 630. This step is the same as or similar to the candidate set formation described in step 220 of FIG. 2 and steps 420-440 of FIG. 4, except that the selection is applied only to the chosen layers from step 620.

In one embodiment, nearest-neighbor candidate reduction is used, where constellation points closest to the filter output are selected to form the initial candidate set. In another embodiment, one-dimensional axis-based selection is used, where candidates are drawn from I and Q axes and combined into a cross-shaped set. The number of candidates may be fixed or adapted according to channel conditions, SNR or modulation order.

Following candidate set formation, IC or slicing is performed to resolve the remaining symbols that were not explicitly selected as candidates. For example, as shown in FIG. 5, block 535a represents determining symbols x₁, x₂, . . . , x₇ given a candidate for x₀, while block 535b represents determining symbols x₀, x₂, . . . , x₇ given a candidate for x₁. By combining reduced candidate sets with IC, the detector accounts for symbol interactions without evaluating the full constellation across all layers.

This step contributes to the reduction in computational complexity. Instead of performing full multidimensional candidate expansion, only a subset of layers undergo candidate set formation, and the remainder are resolved through IC or simplified decision strategies.

At 650, the detector computes EDs for the candidate hypotheses formed in step 640 and determines minimum distance metrics for the selected layers. This step is the same as or similar to the distance evaluations described in step 240 of FIG. 2, but here the calculations are carried out only for the subset of layers chosen in step 620.

In one embodiment, the ED between the received signal vector and a hypothesized candidate symbol vector is computed for each candidate. These distances provide a measure of how closely each candidate matches the observed signal. For example, as illustrated in FIG. 5, blocks 540a and 540b represent ED computations for branches corresponding to candidates of x₀ and x₁, respectively.

Following ED calculation, the detector determines the minimum ED values for each relevant bit hypothesis. At 545a and 545b, shown in FIG. 5, the minimum distances are evaluated for symbol bits of x₀, x₁, x₂, and x₃ across the two branches. By identifying the minimum distance associated with each bit value, the detector establishes the likelihood foundation for subsequent LLR computation.

Because only a subset of detection layers undergo candidate selection and ED evaluation, the number of distance computations is significantly reduced compared to conventional full-layer processing.

At 660, the detector combines the results of the ED evaluations from step 650 to compute LLRs for the bits across the selected and omitted detection layers. This step is the same as or similar to steps 240-260 of FIG. 2 and step 460 of FIG. 4, but applied in the reduced-layer framework shown in FIG. 5.

In one embodiment, per-branch LLRs are first computed by comparing the minimum EDs associated with different bit hypotheses. These branch-level results are then aggregated in a joint LLR calculation (e.g., block 550 in FIG. 5), which fuses information across the reduced set of layers. Because omitted layers did not undergo candidate set selection, their bit values may be determined using hard symbol decisions or simplified likelihood estimates.

To ensure numerical stability, the detector applies a bounding operation to the computed LLRs. In one embodiment, bounding is performed by saturation or clipping, where LLR values above a positive threshold or below a negative threshold are capped at fixed limits. In another embodiment, adaptive thresholds may be applied, varying according to channel reliability or modulation order. Bounding prevents extreme LLR magnitudes that may arise from reduced candidate sets or omitted layers, ensuring that the final soft outputs remain reliable.

The bounded LLRs are then provided as outputs for decoding by a channel decoder, such as a turbo or LDPC decoder. By combining branch-level LLRs with bounding, the reduced detection layer method achieves reliable soft-output performance while significantly lowering computational requirements compared to full-layer detection.

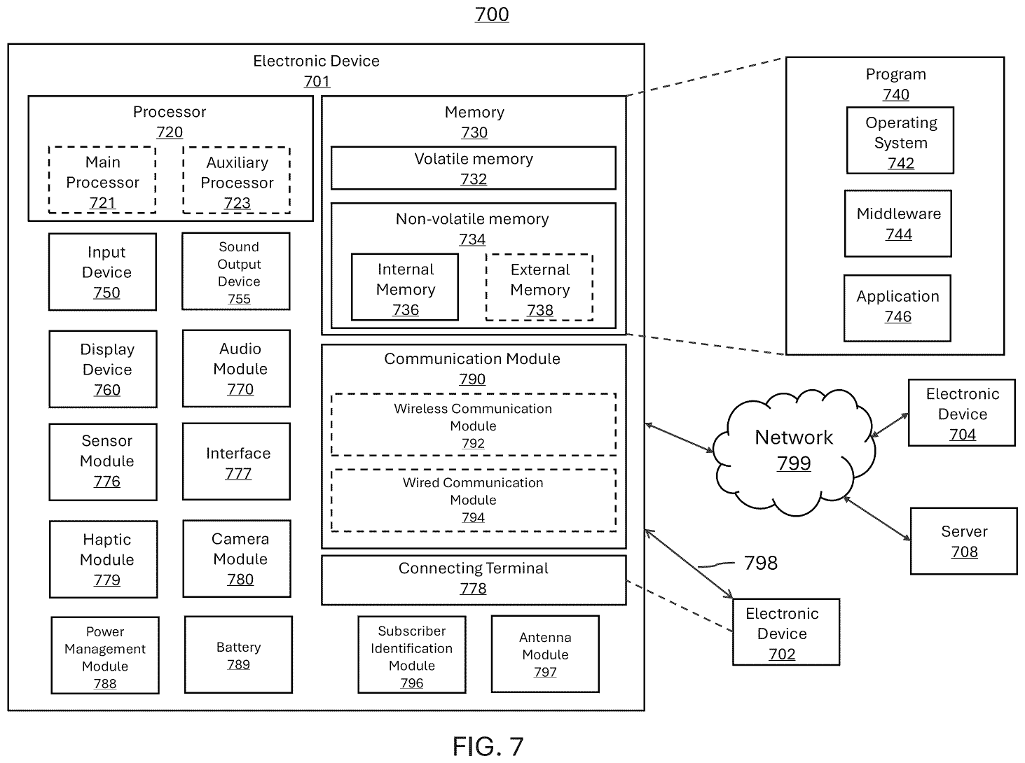

FIG. 7 is a block diagram of an electronic device in a network environment 700, according to an embodiment.

Referring to FIG. 7, an electronic device 701 in a network environment 700 may communicate with an electronic device 702 via a first network 798 (e.g., a short-range wireless communication network), or an electronic device 704 or a server 708 via a second network 799 (e.g., a long-range wireless communication network). The electronic device 701 may communicate with the electronic device 704 via the server 708. The electronic device 701 may include a processor 720, a memory 730, an input device 750, a sound output device 755, a display device 760, an audio module 770, a sensor module 776, an interface 777, a haptic module 779, a camera module 780, a power management module 788, a battery 789, a communication module 790, a subscriber identification module (SIM) card 796, or an antenna module 797. In one embodiment, at least one (e.g., the display device 760 or the camera module 780) of the components may be omitted from the electronic device 701, or one or more other components may be added to the electronic device 701. Some of the components may be implemented as a single integrated circuit (IC). For example, the sensor module 776 (e.g., a fingerprint sensor, an iris sensor, or an illuminance sensor) may be embedded in the display device 760 (e.g., a display).

The processor 720 may execute software (e.g., a program 740) to control at least one other component (e.g., a hardware or a software component) of the electronic device 701 coupled with the processor 720 and may perform various data processing or computations.

As at least part of the data processing or computations, the processor 720 may load a command or data received from another component (e.g., the sensor module 776 or the communication module 790) in volatile memory 732, process the command or the data stored in the volatile memory 732, and store resulting data in non-volatile memory 734. The processor 720 may include a main processor 721 (e.g., a central processing unit (CPU) or an application processor (AP)), and an auxiliary processor 723 (e.g., a graphics processing unit (GPU), an image signal processor (ISP), a sensor hub processor, or a communication processor (CP)) that is operable independently from, or in conjunction with, the main processor 721. Additionally or alternatively, the auxiliary processor 723 may be adapted to consume less power than the main processor 721, or execute a particular function. The auxiliary processor 723 may be implemented as being separate from, or a part of, the main processor 721.

The auxiliary processor 723 may control at least some of the functions or states related to at least one component (e.g., the display device 760, the sensor module 776, or the communication module 790) among the components of the electronic device 701, instead of the main processor 721 while the main processor 721 is in an inactive (e.g., sleep) state, or together with the main processor 721 while the main processor 721 is in an active state (e.g., executing an application). The auxiliary processor 723 (e.g., an image signal processor or a communication processor) may be implemented as part of another component (e.g., the camera module 780 or the communication module 790) functionally related to the auxiliary processor 723.

The memory 730 may store various data used by at least one component (e.g., the processor 720 or the sensor module 776) of the electronic device 701. The various data may include, for example, software (e.g., the program 740) and input data or output data for a command related thereto. The memory 730 may include the volatile memory 732 or the non-volatile memory 734. Non-volatile memory 734 may include internal memory 736 and/or external memory 738.

The program 740 may be stored in the memory 730 as software, and may include, for example, an operating system (OS) 742, middleware 744, or an application 746.

The input device 750 may receive a command or data to be used by another component (e.g., the processor 720) of the electronic device 701, from the outside (e.g., a user) of the electronic device 701. The input device 750 may include, for example, a microphone, a mouse, or a keyboard.

The sound output device 755 may output sound signals to the outside of the electronic device 701. The sound output device 755 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 760 may visually provide information to the outside (e.g., a user) of the electronic device 701. The display device 760 may include, for example, a display, a hologram device, or a projector and control circuitry to control a corresponding one of the display, hologram device, and projector. The display device 760 may include touch circuitry adapted to detect a touch, or sensor circuitry (e.g., a pressure sensor) adapted to measure the intensity of force incurred by the touch.

The audio module 770 may convert a sound into an electrical signal and vice versa. The audio module 770 may obtain the sound via the input device 750 or output the sound via the sound output device 755 or a headphone of an external electronic device 702 directly (e.g., wired) or wirelessly coupled with the electronic device 701.

The sensor module 776 may detect an operational state (e.g., power or temperature) of the electronic device 701 or an environmental state (e.g., a state of a user) external to the electronic device 701, and then generate an electrical signal or data value corresponding to the detected state. The sensor module 776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 777 may support one or more specified protocols to be used for the electronic device 701 to be coupled with the external electronic device 702 directly (e.g., wired) or wirelessly. The interface 777 may include, for example, a high-definition multimedia interface (HDMI), a universal serial bus (USB) interface, a secure digital (SD) card interface, or an audio interface.

A connecting terminal 778 may include a connector via which the electronic device 701 may be physically connected with the external electronic device 702. The connecting terminal 778 may include, for example, an HDMI connector, a USB connector, an SD card connector, or an audio connector (e.g., a headphone connector).

The haptic module 779 may convert an electrical signal into a mechanical stimulus (e.g., a vibration or a movement) or an electrical stimulus which may be recognized by a user via tactile sensation or kinesthetic sensation. The haptic module 779 may include, for example, a motor, a piezoelectric element, or an electrical stimulator.

The camera module 780 may capture a still image or moving images. The camera module 780 may include one or more lenses, image sensors, image signal processors, or flashes. The power management module 788 may manage power supplied to the electronic device 701. The power management module 788 may be implemented as at least part of, for example, a power management integrated circuit (PMIC).

The battery 789 may supply power to at least one component of the electronic device 701. The battery 789 may include, for example, a primary cell which is not rechargeable, a secondary cell which is rechargeable, or a fuel cell.

The communication module 790 may support establishing a direct (e.g., wired) communication channel or a wireless communication channel between the electronic device 701 and the external electronic device (e.g., the electronic device 702, the electronic device 704, or the server 708) and performing communication via the established communication channel. The communication module 790 may include one or more communication processors that are operable independently from the processor 720 (e.g., the AP) and supports a direct (e.g., wired) communication or a wireless communication. The communication module 790 may include a wireless communication module 792 (e.g., a cellular communication module, a short-range wireless communication module, or a global navigation satellite system (GNSS) communication module) or a wired communication module 794 (e.g., a local area network (LAN) communication module or a power line communication (PLC) module). A corresponding one of these communication modules may communicate with the external electronic device via the first network 798 (e.g., a short-range communication network, such as BLUETOOTH™, wireless-fidelity (Wi-Fi) direct, or a standard of the Infrared Data Association (IrDA)) or the second network 799 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 792 may identify and authenticate the electronic device 701 in a communication network, such as the first network 798 or the second network 799, using subscriber information (e.g., international mobile subscriber identity (IMSI)) stored in the subscriber identification module 796.

The antenna module 797 may transmit or receive a signal or power to or from the outside (e.g., the external electronic device) of the electronic device 701. The antenna module 797 may include one or more antennas, and, therefrom, at least one antenna appropriate for a communication scheme used in the communication network, such as the first network 798 or the second network 799, may be selected, for example, by the communication module 790 (e.g., the wireless communication module 792). The signal or the power may then be transmitted or received between the communication module 790 and the external electronic device via the selected at least one antenna.

Commands or data may be transmitted or received between the electronic device 701 and the external electronic device 704 via the server 708 coupled with the second network 799. Each of the electronic devices 702 and 704 may be a device of a same type as, or a different type, from the electronic device 701. All or some of operations to be executed at the electronic device 701 may be executed at one or more of the external electronic devices 702, 704, or 708. For example, if the electronic device 701 should perform a function or a service automatically, or in response to a request from a user or another device, the electronic device 701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 701. The electronic device 701 may provide the outcome, with or without further processing of the outcome, as at least part of a reply to the request. To that end, a cloud computing, distributed computing, or client-server computing technology may be used, for example.

The methods of MIMO detection described herein, including candidate reduction and reduced detection layers, may be implemented by the processor 720 (e.g., the main processor 721 or auxiliary processor 723) of the electronic device 701, or by the communication module 790 (e.g., the wireless communication module 792) that performs MIMO signal processing functions.

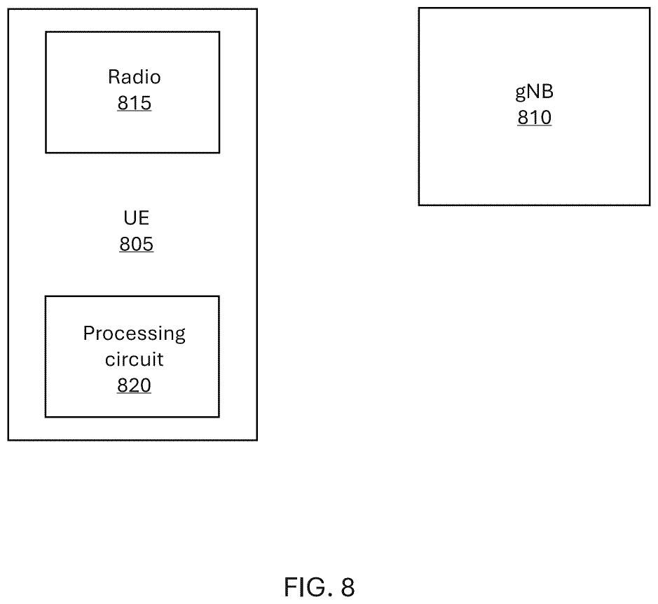

FIG. 8 shows a system including a UE 805 and a gNB 810, in communication with each other. The UE may include a radio 815 and a processing circuit (or a means for processing) 820, which may perform various methods disclosed herein, e.g., the method illustrated in FIG. 1. For example, the processing circuit 820 may receive, via the radio 815, transmissions from the network node (gNB) 810, and the processing circuit 820 may transmit, via the radio 815, signals to the gNB 810.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method of detecting signals in a multiple-input multiple-output (MIMO) communication system, comprising:
receiving a signal vector and a channel matrix;
computing, for a detection layer, a filter output based on the signal vector and the channel matrix;
selecting, as an initial candidate set for the detection layer, a plurality of constellation points;
identifying one or more bits using the initial candidate set;
computing log-likelihood ratios (LLRs) for the one or more bits;
applying a bounding operation to the LLRs to produce bounded LLRs; and
outputting the bounded LLRs for decoding.

2. The method of claim 1, wherein the initial candidate set comprises nearest constellation points to the filter output.

3. The method of claim 1, wherein the initial candidate set is selected without using a counter-hypothesis constellation point for each of the one or more bits.

4. The method of claim 1, wherein the bounding operation comprises saturation or clipping of the LLRs.

5. The method of claim 1, wherein the filter output comprises a linear minimum mean square error (LMMSE) output.

6. The method of claim 1, wherein the plurality of constellation points are determined according to a distance from the filter output.

7. The method of claim 1, wherein computing the LLRs comprises determining symbol likelihoods from the initial candidate set and mapping the symbol likelihoods to bit values.

8. The method of claim 1, wherein the method is performed by a modem.

9. The method of claim 1, further comprising:
for each constellation point in the initial candidate set of the detection layer, computing a corresponding constellation point for each remaining detection layer;
for each candidate vector comprising a constellation point of the detection layer and corresponding constellation points of the remaining detection layers, computing a distance metric using the signal vector and the channel matrix; and
combining sets of candidate vectors corresponding to different detection layers.

10. The method of claim 9, wherein computing the LLRs comprises using distance metrics of candidate vectors formed from the detection layer and the remaining detection layers.

11. A method of detecting signals in a multiple-input multiple-output (MIMO) communication system, comprising:
receiving a signal vector and a channel matrix;
computing, for a detection layer, a filter output based on the signal vector and the channel matrix;
forming a first set of candidate constellation points along a first axis of the filter output;
forming a second set of candidate constellation points along a second axis of the filter output;
combining the first and second sets to form an initial candidate set for the detection layer;
identifying one or more bits using the initial candidate set;
computing log-likelihood ratios (LLRs) for the one or more bits;
applying a bounding operation to the LLRs to produce bounded LLRs; and
outputting the bounded LLRs for decoding.

12. The method of claim 11, wherein the first axis is an in-phase axis of the filter output and the second axis is a quadrature axis of the filter output.

13. The method of claim 11, wherein each of the first and second sets comprises a predetermined number of nearest constellation points.

14. The method of claim 11, wherein the initial candidate set forms a cross-shaped subset of the constellation points.

15. The method of claim 11, wherein the initial candidate set is selected without using a counter-hypothesis constellation point for each of the one or more bits.

16. The method of claim 11, wherein the bounding operation comprises saturation or clipping of the LLRs.

17. The method of claim 11, wherein the filter output comprises a linear minimum mean square error (LMMSE) output.

18. A method of detecting signals in a multiple-input multiple-output (MIMO) communication system, comprising:
receiving a signal vector and a channel matrix;
computing filter outputs for a plurality of layers;
selecting an initial candidate set of constellation points for one or more of the layers;
computing corresponding constellation points for remaining layers without forming a candidate set for those layers;
identifying one or more bits from the plurality of layers, including the remaining layers;
computing log-likelihood ratios (LLRs) for the one or more bits;
applying a bounding operation to the LLRs to produce bounded LLRs; and
outputting the bounded LLRs for decoding.

19. The method of claim 18, wherein computing corresponding constellation points for the remaining layer comprises applying a hard symbol decision.
